(19) United States
(12) Patent Application Publication
(10) Pub. No.: US 2011/0019652 A1
(43) Pub. Date: Jan. 27, 2011

(54) MOBILE SPECTRUM SHARING WITH INTEGRATED WiFi

(75) Inventor: Peter Atwal, Longwood, FL (US)

Correspondence Address: STRATEGIC PATENTS P.C.., C/O PORTFOLIOIP, P.O. BOX 52050, MINNEAPOLIS, MN, 55402, US

(73) Assignee: POWERWAVE COGNITION, INC., Santa Ana, CA (US)

(21) Appl. No.: 12/815,069

(22) Filed: Jun. 14, 2010

Related U.S. Application Data
(60) Provisional application No. 61/313,723, filed on Mar. 13, 2010.
(60) Provisional application No. 61/187,656, filed on Jun. 16, 2009.

(51) Int. Cl. H04W 84/02; H04B 7/212

(52) U.S. Cl. 370/338; 370/347

(57) ABSTRACT

Methods and systems are disclosed for realizing MBRI networks and network devices using commercial off-the-shelf components (e.g., chipsets) conforming to the 802.11 networking standards. In particular, a physical layer is provided at or below the medium access control layer that adapts the lowest level of a hardware chipset to the MBRI protocol. Also disclosed are methods of managing and operating an integrated MBRI router that supports a tightly or loosely coupled WiFi MAC and PHY layer operations in an all-IP mobile ad hoc network (MANET) with carrier grade network performance and improved spectrum utilization through IP transparent routing, media access control and physical layer convergence protocols.

### CROSS-REFERENCE TO RELATED APPLICATIONS

This application claims priority to U.S. Provisional Application Ser. No. 61/187,656, filed on Jun. 16, 2009 and having Attorney Docket No. COGN-0054-P60, and U.S. Provisional Application Ser. No. 61/313,723, filed on Mar. 13, 2010 and having Attorney Docket No. COGN-0058-P60, each of which is incorporated herein by reference in its entirety.

### FIELD OF THE INVENTION

The invention herein disclosed generally refers to data communications and networking, and more particularly to mobile networking.

### BACKGROUND

Existing wireless communications used in carrier-grade networks typically consist of a cell-based infrastructure where all mobile subscriber nodes must communicate directly with a network base station. As an alternative, wireless communications (such as the well known WiFi networks) may utilize a mobile ad hoc network (MANET), where any mobile node can communicate with any other node, either directly or through multiple hops across the network topology. However, existing mobile ad hoc networks sometimes operate without any network infrastructure on a single fixed spectrum channel. There exists a need to provide mobile broadband routable internet (MBRI) networks with integrated WiFi.

In addition, the proliferation of WiFi devices had led to cheaply available chipsets implementing various aspects of the IEEE 802.11 WiFi standards. There exists a further need for adaptations of existing 802.11 hardware for use with ad hoc networks such as MBRI.

### SUMMARY

Methods and systems are disclosed for managing and operating an integrated MBRI router that supports a tightly or loosely coupled WiFi MAC and PHY layer operations in an all IP mobile ad hoc network with carrier grade network performance and improved spectrum utilization through IP transparent routing, media access control and physical layer convergence protocols comprising a plurality of wireless mobile nodes and a plurality of wireless communication links connecting the plurality of nodes. In embodiments, the methods and systems may facilitate real-time and non real-time downloading of node specific and network specific protocols for integration of MBRI nodes and end user devices with WiFi. In further embodiments, the methods and systems may facilitate real-time and non real-time downloading of node specific and network wide applets, servlets, and client applications for integration of MBRI nodes and end user devices with WiFi.

Additionally, methods and systems are disclosed for realizing MBRI networks and network devices using commercial off-the-shelf components conforming to the 802.11 networking standards. In particular, a physical layer (which may be implemented in hardware, software, or a combination of these) is provided at or below the MAC layer that adapts the lowest level of a hardware chipset to the MBRI protocol. As described in greater detail herein, this may include suppressing or disabling certain operations of the 802.11 chipset, and augmenting functionality of the protocol stack to provide various higher-level functions (e.g., network, routing, and other functions) of the MBRI protocol within or through the physical layer.

In one aspect, there is disclosed herein a method for operating a network device that includes disabling at least one function of an 802.11 chipset and providing at least one MBRI function in a physical layer application programming interface for the 802.11 chipset.

### BRIEF DESCRIPTION OF THE FIGURES

The invention and the following detailed description of certain embodiments thereof may be understood by reference to the following figures:

FIG. 1A depicts an embodiment of a collection of wireless radio nodes in a mobile ad-hoc wireless network according to an embodiment of the present invention.

FIG. 1B depicts an embodiment of a collection of wireless radio nodes in a mobile ad-hoc wireless network according to an embodiment of the present invention, where the radio nodes are shown as nodes linked together into the mobile ad-hoc wireless network.

FIG. 2A depicts an embodiment of a wireless mesh network according to an embodiment of the present invention, where access points are shown in relation to the network's connection to a fixed network.

FIG. 2B depicts embodiment of a wireless mesh network according to an embodiment of the present invention, where subscriber nodes are shown linked to access points.

FIG. 3 depicts an embodiment of a wireless network with access points back to the fixed Internet.

FIG. 4 depicts an embodiment of a wireless network showing multiple pathways from a particular mobile network node to the fixed Internet.

FIG. 5 depicts an embodiment of the MBRI stack showing layers from device down to physical layer.

FIG. 6 depicts an embodiment of the MBRI stack showing the addition of DySAN capabilities.

FIG. 7 depicts an embodiment of the use of dynamic spectrum access technology to wireless communication according to an embodiment of the present invention.

FIG. 8 depicts an embodiment of the mobile ad-hoc wireless network using dynamic spectrum access technology according to an embodiment of the present invention.

FIG. 9 depicts an embodiment of DySAN spectrum aware routing.

FIG. 10 depicts coexistence of MBRI and WiFi.

FIG. 11 depicts temporal avoidance according to one embodiment of the present invention.

FIG. 12 depicts full frequency avoidance according to one embodiment of the present invention.

FIG. 13 depicts partial frequency avoidance according to one embodiment of the present invention.

FIG. 14 depicts multiple levels of multi-mode device integration according to one embodiment of the present invention.

FIG. 15 depicts another view of the MBRI protocol stack according to one embodiment of the present invention.

FIG. 16 illustrates a slotted TDMA timing structure according to one embodiment of the present invention.

FIG. 17 is a block diagram of an exemplary MBRI-802.11 PHY layer integration according to one embodiment of the present invention.

While the invention has been described in connection with certain preferred embodiments, other embodiments would be understood by one of ordinary skill in the art and are encompassed herein.

### DETAILED DESCRIPTION

The present disclosure provides a mobile broadband routable internet (MBRI) for providing carrier-grade, networked, broadband, IP-routable communication among a plurality of mobile devices, where the mobile devices may represent a plurality of nodes that are linked together through a mobile ad hoc network (MANET). Mobile devices, also referred to herein where context permits as subscriber devices, may operate as peers in a peer-to-peer network, with full IP routing capabilities enabled within each subscriber device, thereby allowing routing of IP-based traffic, including deployment of applications, to the subscriber device without need for infrastructure conventionally required for mobile ad hoc networks, such as cellular telephony infrastructure. Full IP-routing to subscriber devices allows seamless integration to the fixed Internet, such as through fixed or mobile access points, such as for backhaul purposes. Thus, the MBRI may function as a standalone mobile Internet, without connection to the fixed Internet, or as an IP-routable extension of another network, whether it be the Internet, a local area network, a wide area network, a cellular network, a personal area network, or some other type of network that is capable of integration with an IP-based network. The capabilities that enable the MBRI are disclosed herein, such capabilities including the software, technology components and processes for physical (PHY) layer, media (or medium) access control (MAC) layer, and routing (or network) layer capabilities that allow all IP-based traffic types and applications to use the MBRI, embodied across a set of mobile devices, as if it were an 802.1 through 802.3 compliant fixed network, without reliance on, or intervention by, fixed network infrastructure components such as application-specific Internet servers or cellular infrastructure components.

The features of the present invention, which are believed to be novel, are set forth with particularity in the appended claims. The invention may best be understood by reference to the following description, taken in conjunction with the accompanying drawings.

While the specification concludes with the claims defining the features of the invention that are regarded as novel, it is believed that the invention will be better understood from a consideration of the following description in conjunction with the drawings figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “another,” as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

### MANET and the MBRI Protocols

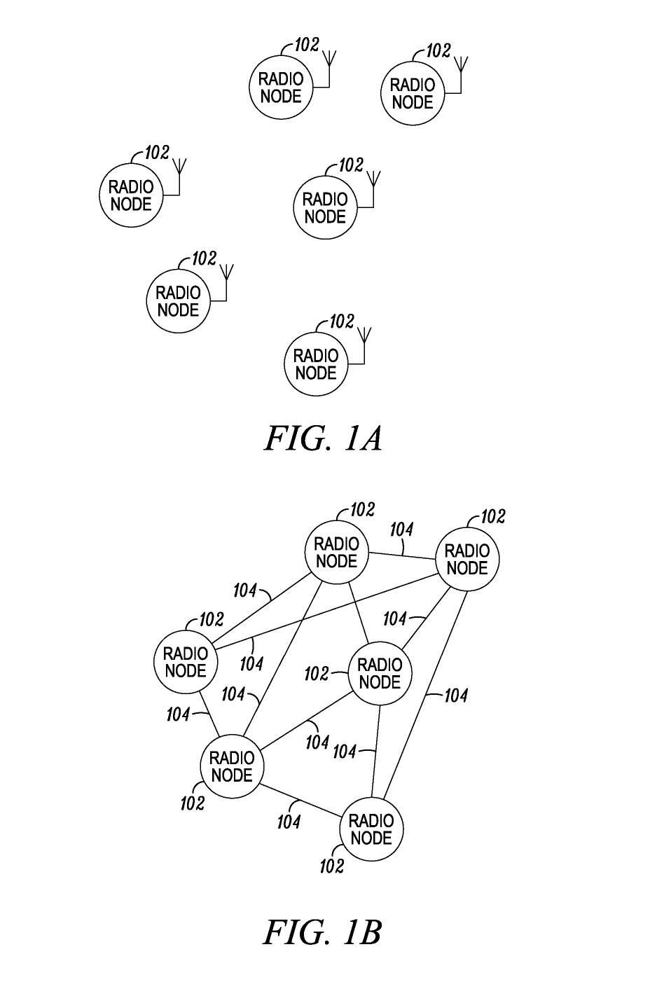

FIG. 1A illustrates a Mobile Ad Hoc Wireless Network (MANET) as used in embodiments of the present invention. Such networks are known in the art and are described in detail in, for example, U.S. application Ser. No. 12/418,363, filed on Apr. 3, 2009 (Attorney Docket No. COGN-0053-P01) and incorporated herein by reference in its entirety. As shown in FIG. 1A, the wireless network may have a set of wireless devices capable of communicating wirelessly. Each wireless device may be termed as a node 102. A node 102 may communicate with any other node 102, and as shown in FIG. 1B, links 104 may be formed between nodes 102. The mobile ad-hoc network may include nodes 102 that are mobile, as well as nodes 102 that are fixed. In embodiments, the fixed nodes may enable the creating of a spanning network to establish initial wireless coverage across a geographic area. In addition, a subset of these nodes 102 may have connectivity to a fixed (i.e., wired) network. In a mobile ad-hoc wireless network, routing through the network may find the ‘best’ path to destination including ‘multi-hop’ relay across multiple wireless nodes. The wireless network may be capable of autonomously forming and re-forming links and routes through the network. This dynamic forming and re-forming of links 104 and routes may be made to adjust to changing conditions resulting from node mobility, environmental conditions, traffic loading, and the like. Thus, mobile ad-hoc wireless network's wireless topology may change rapidly and unpredictably.

Establishing a quality of service may be an essential quality for the mobile ad-hoc wireless network. In embodiments, quality of service for a mobile ad-hoc wireless network may be measured in terms of the amount of data that the network successfully transfers from one place to another over a period of time. Currently used mobile ad-hoc networks may have a number of issues with respect to network quality of service, such as application routing-focused communication without the ability to provide service-level agreements for quality-of-service, providing only unicast services, link-focused power control, providing a single data rate only, providing contention-based access (e.g., focus on inefficient unlicensed band radios), focused on military or public safety applications, congestion and dynamic and unpredictable latency (especially with multi-hop scenarios), and the like. In embodiments, the present invention may provide for a mobile ad-hoc network that significantly improves on the shortcomings of current systems.

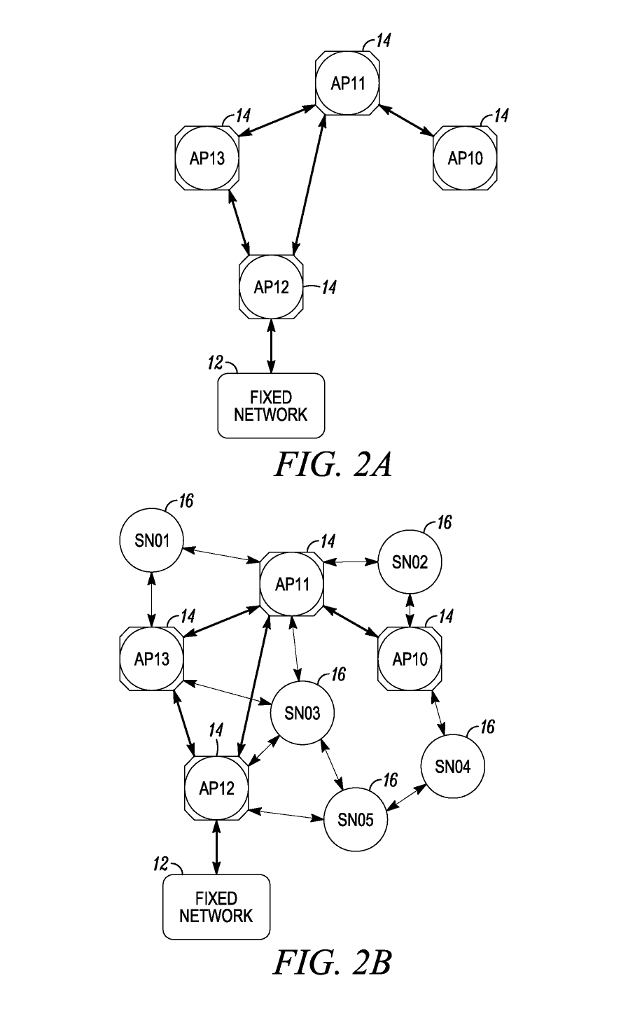

FIGS. 2A and 2B illustrate a wireless mesh network according to an embodiment of the present invention. The wireless mesh network may be a type of wireless ad-hoc network that allows multi-hop routing. Wireless mesh network architecture may sustain communications by breaking long distances into a series of shorter hops. As shown in FIG. 2A, the wireless mesh network may have a subset of nodes 102 designated as access points 14 to form a spanning network to establish initial wireless network coverage across a geographical area. In an embodiment, one or more access points may have a connection interface to a fixed network 12. In embodiments, the fixed network 12 that the access points 14 connect to may be any known fixed network, such as the Internet, a LAN, a WAN, a cell network, and the like. As shown in FIG. 2B, a subset of nodes 102 may be designated as ‘subscriber nodes’ 16 that may form links 104 among themselves and to the spanning network to augment wireless coverage. This may allow nodes 102 connectivity to the fixed network 12 via multiple hops across wireless topology. This topology may also change with node mobility. In embodiments, a wireless mesh network may be termed as a mobile ad-hoc network if the nodes 102 in a wireless mesh network are mobile.

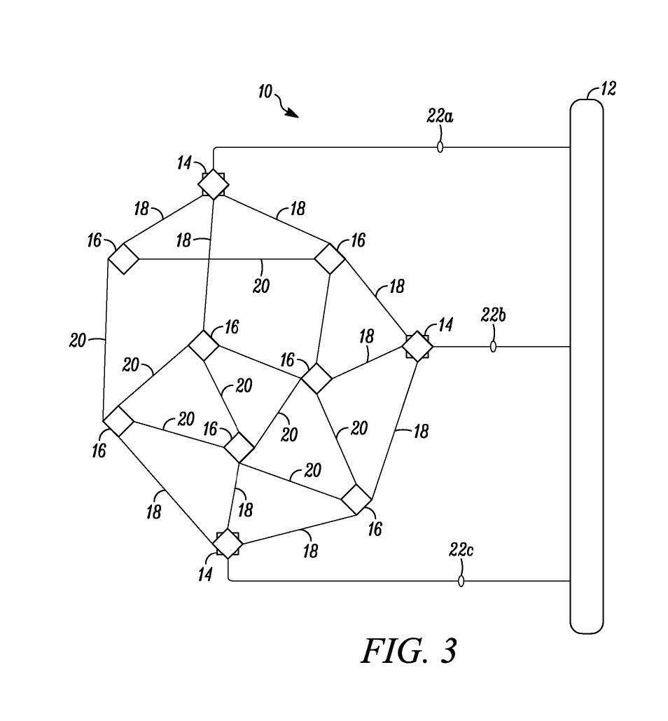

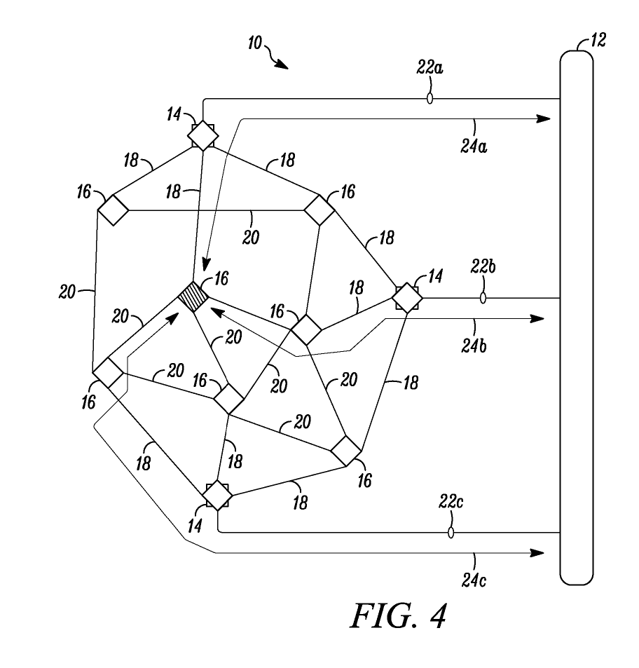

FIG. 3 depicts a mobile ad-hoc network with backhaul 10 to a fixed network 12. Here, the mobile ad-hoc network is shown to include a plurality of mobile nodes 16, a plurality of fixed nodes 14, a plurality of access points 14, a plurality of mobile node to fixed node links 18, a plurality of mobile node to mobile node links 20, the fixed network 12, and a plurality of fixed node to fixed network links 22a-c. In embodiments, the fixed nodes 14 may provide network structure, such as to provide a spanning network that enables the establishment of the ad-hoc network, as well as connectivity to the fixed network. Mobile nodes 16 may then establish links 18 to both fixed nodes 14 and to other mobile nodes 20, where all of the nodes 14,16 and links 18, 20 establish the mobile ad-hoc network with links 22a-c to the fixed network 12. FIG. 4 illustrates three example network pathway routings 24a-c for a mobile node 16 establishing connectivity to the fixed network 12, including a link combination 24a from the fixed network 12 to a fixed node 14 and then to the destination mobile node 16, a link combination 22b to a fixed node 14 through an intermediate mobile node 16 and then to the destination mobile node, and an alternate link combination 22c to a fixed node 14 through an intermediate mobile node 16 and then to the destination mobile node. In embodiments, the link combinations may include any number of mobile nodes 16, fixed nodes 14, subscriber nodes, access points, and the like.

In embodiments, the mobile ad-hoc network may also provide a plurality of network services and attributes, such as autonomous neighbor discovery and maintenance, distributed network timing reference dissemination, dynamic frame structure, distributed scheduling with dynamic selection of scheduling algorithms (e.g., such as based on network topology, traffic load, spectrum availability), link-by-link autonomous data rate selection, traffic differentiation across the protocol stack (e.g. priority queuing and priority channel access), ARQ automatic repeat and request capability, geo-location capability for E-911 and location-based services, power control for intra-network interference management and spectrum reuse, unicast and multicast routing, interfacing in a standard way to existing IP core network nodes, encryption and authentication, OSS with EMS and NMS, and the like.

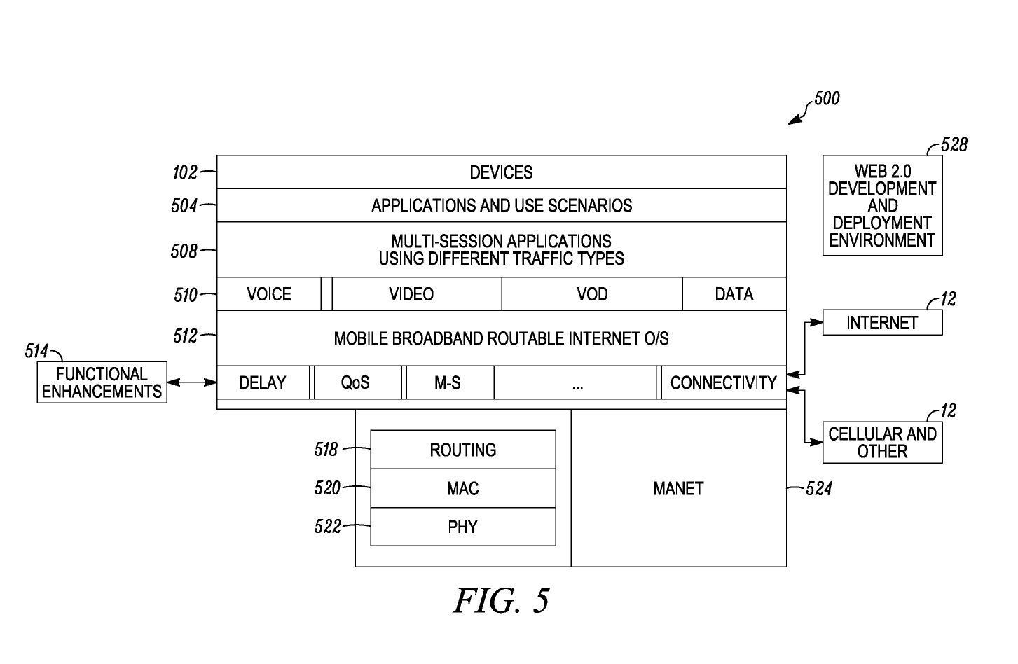

FIG. 5 depicts the MBRI as a hierarchical stack 500. At the top of the MBRI stack are the devices 102, including mobile subscriber devices (SD) 16, fixed node communication devices, access points 14, and the like. The next two layers down represent applications and use scenarios 504, and multi-session applications using different traffic types 508, which may be utilized or executed by the devices 502 in conjunction with the MBRI. Continuing down to the next layer, are data applications that may be carried 510 across the MBRI, including data, voice, video, video on demand (VOD), and the like. Next is the MBRI operating system 512. Next, the MBRI stack shows a representative subset of the MBRI functional enhancements 514, as described herein, which may be provided as optional elements in the MBRI system. The MBRI thus far, may then be enabled from the stack elements below, including a core stack of routing 518, MAC 520, and physical layers 522, as shown in the middle, which may provide fixed Internet equivalency in a mobile ad-hoc network 524. In addition, connectivity is also shown to other communication facilities, such as the fixed networks 12 as described herein. In embodiments, the MBRI may be built up from various combinations and sub-combinations of the various components of the MBRI stack, which may enable various applications, devices, and the like, the ability to deploy applications directly to the device. In embodiments, the MBRI stack may provide a solution with high quality of service transport for multi-session applications, replicate functions that may be effectively analogous to the foundation standards of the IETF defined internet within the mobility sector, enable functions analogous to each of the functions in the IETF 802.1-3 fixed Internet stack provide services associated with Web 2.0 development and deployment environment 528, and the like. In embodiments, the MBRI may represent a mobile ad-hoc network with true Internet routing capability.

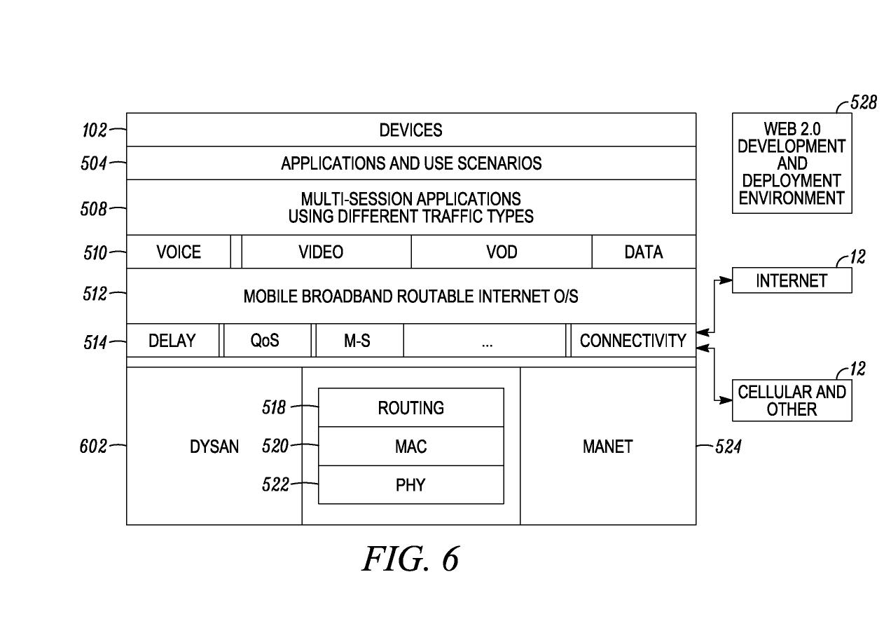

FIG. 6 shows the MBRI stack as introduced in FIG. 5, but with dynamic spectrum access (DySAN) 602 added as an option. Currently dynamic spectrum access technologies may be focused on limited aspects of network performance, such as on TV bands, finding spectrum for the whole network, trying to avoid interference through power control, and the like. Dynamic spectrum access 602, as a part of MBRI, may provide spectrum used to communicate wirelessly between nodes changes in a non-pre-determined manner in response to changing network and spectrum conditions. In embodiments, the time scale of dynamics may be typically less than can be supported by engineering analysis, network re-planning, optimization, and the like. For instance, in response to manual or automated decisions, where there may be centralized decisions (e.g., network partitioning) or distributed local decisions of the individual nodes. Dynamic spectrum access may be able to avoid interference to/from geographically proximate spectrum users internal or external to their own wireless network. Dynamic spectrum access 602 may also be able to access and utilize spectrum otherwise unavailable for wireless network use. In embodiments, local spectrum decisions may be coordinated and/or communicated using a fixed or logical control channel in an over-the-air wireless network.

DySAN technology is a proven set of techniques for spectrum sharing. This technology is described in (but not limited to) U.S. patent application Ser. Nos. 11/595,719, filed on Nov. 10, 2006 (Attorney Docket No. COGN-0020-P01); 11/548,763, filed on Oct. 12, 2006 (Attorney Docket No. COGN-0009-P01); 11/595,493, filed on Nov. 10, 2006 (Attorney Docket No. COGN-0014-P01); 11/772,691, filed on Jul. 2, 2007 (Attorney Docket No. COGN-0015-P02); 11/595,542, filed on Oct. 6, 2006 (Attorney Docket No. COGN-0016-P01); 11/595,716, filed on Nov. 10, 2006 (Attorney Docket No. COGN-0017-P01); 11/595,717, filed on Nov. 10, 2006 (Attorney Docket No. COGN-0018-P01); and 11/595,740, filed on Nov. 10, 2006 (Attorney Docket No. COGN-0019-P01), each of which is incorporated herein by reference in its entirety,

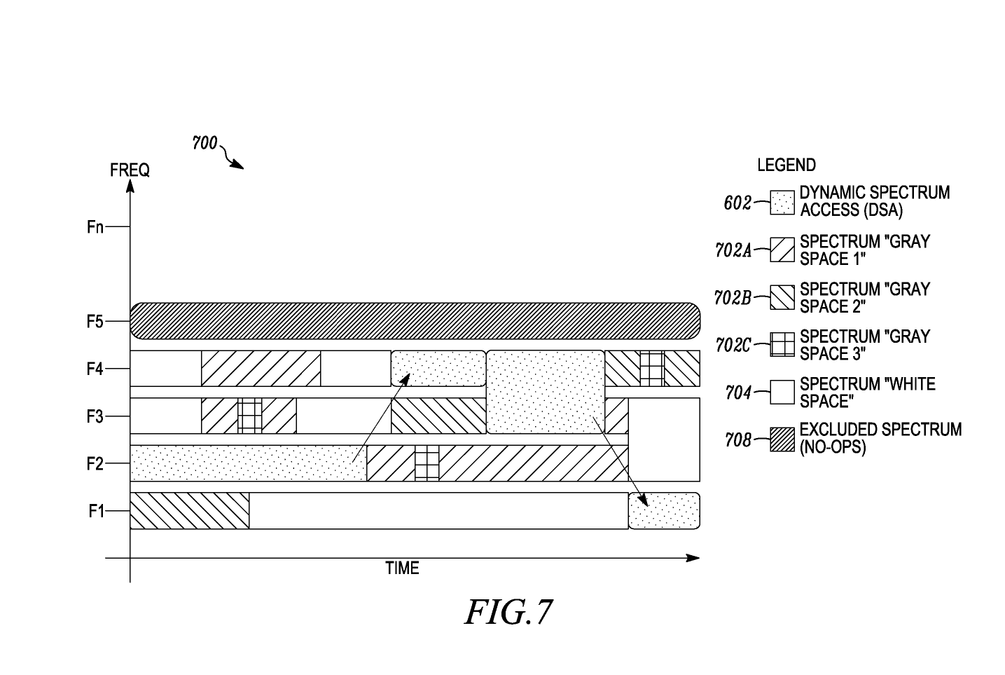

FIG. 7 illustrates the use of dynamic spectrum access technology 700 to wireless communication according to an embodiment of the present invention. A wireless network may use dynamic spectrum access that provides a dynamic allocation of wireless spectrum to network nodes, such as between the different frequencies F1, F2, F3, F4, and F5. The spectrum may be used to communicate wirelessly between nodes 102 in a non-pre-determined manner in response to changing network and spectrum conditions. Dynamic spectrum access technology may use the methodology of coordination of a collection of wireless nodes 16 to adjust their use of the available RF spectrum. In embodiments, the spectrum may be allocated in response to manual or automated decisions, such as to dynamic spectrum access 602, spectrum gray space 702A, 702B, and 702C, spectrum white space 704, excluded spectrum 708 (e.g. no ops). The spectrum may be allocated in a centralized manner (e.g., network partitioning) or in a distributed manner between individual nodes. The spectrum may be allocated dynamically such that interference to/from geographically proximate spectrum users internal or external to the wireless network may be avoided. The local spectrum decisions may be coordinated/communicated using a fixed or logical control channel in the over-the-air wireless network. This may increase the performance of wireless networks by intelligently distributing segments of available radio frequency spectrum to wireless nodes. Dynamic spectrum access may provide an improvement to wireless communications and spectrum management in terms of spectrum access, capacity, planning requirements, ease of use, reliability, avoiding congestion, and the like.

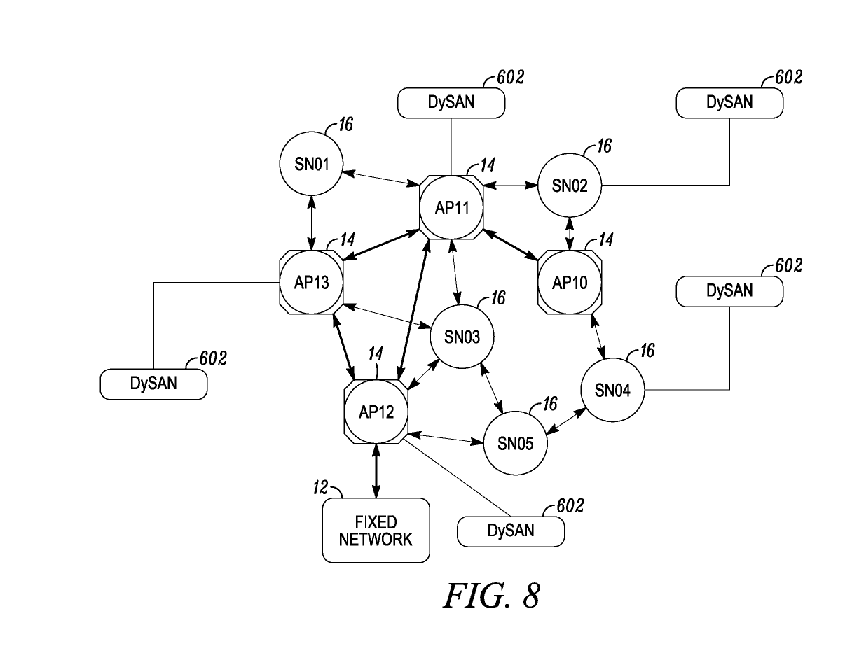

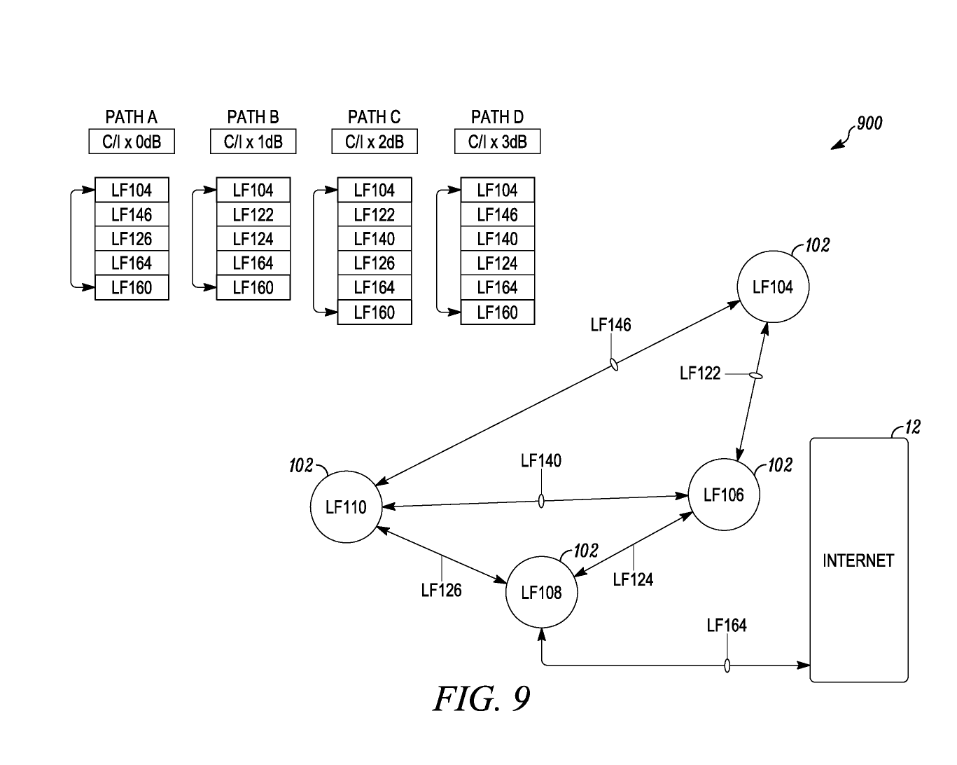

FIG. 8 illustrates a mobile ad-hoc wireless network using dynamic spectrum access technology 602 according to an embodiment of the present invention. In this embodiment, a mobile ad-hoc wireless network may be used in conjunction with dynamic spectrum access technology 602 to provide carrier grade quality of service. A collection of wireless nodes 14, 16 in a mobile ad-hoc network is shown dynamically adapting spectrum usage according to network and spectrum conditions. Individual nodes in the mobile ad-hoc wireless network may make distributed decisions regarding local spectrum usage. In embodiments, quality of service for a mobile ad-hoc wireless network may be measured in terms of the amount of data which the network may successfully transfer from one place to another in a given period of time, and DySAN 602 may provide this through greater utilization of the available spectrum. In embodiments, the dynamic spectrum access technology may provide a plurality of network services and attributes such as, coordinated and uncoordinated distributed frequency assignment, fixed or dynamic network coordination control channel, assisted spectrum awareness (knowledge of available spectrum), tunable aggressiveness for co-existence with uncoordinated external networks, policy-driven for time-of-day frequency and geography, partitioning with coordinated external networks, integrated and/or external RF sensor, and the like. FIG. 9 shows how a spectrum aware path may be selected based on carrier-to-interference ratio 900, in this instance measured in dB (x0 to x3). Basic Encoding Rules (BER) may be used as well to reduce bit errors.

In embodiments, the present invention may implement a method for providing a mobile, broadband, routable internet (MBRI), in which a plurality of mobile devices interact as nodes in a mobile ad hoc network and in which packets are IP routable to the individual device independent of fixed infrastructure elements; enhancing MBRI operation through the use of dynamic adaptation of the operating spectrum; and disseminating spectrum access decisions through use of a logical control channel. In embodiments, adaptation decisions may be made by a centralized controller, in a distributed manner, and the like.

In embodiments, the present invention may implement a system for a mobile, broadband, routable internet (MBRI), in which a plurality of mobile devices interact as nodes in a mobile ad hoc network and in which packets are IP routable to the individual device independent of fixed infrastructure elements; the network capable of enhancing MBRI operation through the use of dynamic adaptation of the operating spectrum; and the network capable of disseminating spectrum access decisions through use of a logical control channel. In embodiments, adaptation decisions may be made by a centralized controller, a distributed manner, and the like.

In embodiments, the MBRI may provide enhancements that better enable carrier-grade service, such as through prioritization of latency-sensitive traffic across multiple layers of the networking protocols to reduce end-to-end latency and jitter (such as by providing priority queuing within node, priority channel access at MAC across nodes and priority routing across topology), providing network support for peer-to-peer connections bypassing network infrastructure, unicast and multicast routing with multiple gateway interfaces to fixed (i.e., wired) network, providing security to protect control-plane and user data and prevent unauthorized network access, traffic shaping and policing to prevent users from exceeding authorized network usage, remote monitoring, control, and upgrade of network devices, automatic re-transmission of loss-sensitive traffic, transparent link and route maintenance during periods of spectrum adaptation, rapid autonomous spectrum adaptation to maintain service quality, avoid interference, and maximize capacity, scalability of network protocols for reliable operation with node densities (e.g., hundreds to thousands of nodes per sq. km.) and node mobility (e.g., to 100 mph) consistent with commercial wireless networks, using adaptive wireless network techniques to maximize scalable network capacity (e.g., adaptive transmit power control to reduce node interference footprint, adaptive link data rate, dynamic hybrid frame structure, dynamic distributed scheduling techniques, multi-channel operation using sub-channels and super-channels, load-leveling routing), simultaneous support of multiple broadband, high mobility network subscribers, interfaces with fixed carrier network (e.g., to support VoIP, SIP, etc.), and the like.

### Coexistence

The presently-disclosed Mobile Broadband Routable Internet (MBRI) solution—in contrast to conventional wireless and fixed wired access networks—may provide for a mobile broadband internet network solution where every subscriber device and infrastructure node may have routing capabilities to allow for intelligent routing decisions enabling intra-network peer-to-peer communications. Traffic between nodes of the MBRI may not need to leave the MBRI network for routing or switching purposes. Instead, because MBRI may be routing enabled, local traffic including required signaling will stay within the MBRI. Also, MBRI allows for inter-network routing since it provides transparent Internet routing capabilities for well known and established internet standards such as Border Gateway Protocol (BGP), Open Shortest Path First (OSPF) routing protocol, Address Resolution Protocol (ARP), Dynamic Host Configuration Protocol (DHCP) and Point to Point Packet (PPP) transmission protocol.

In addition, because of its unique neighbor discovery management and adaptive data rate and power management capabilities, the MBRI may enable local intelligence to be shared across its member nodes leading to the creation and deployment of new classes of services and applications.

Further, because of its Mobile Ad hoc Network (MANET) characteristic, the MBRI may be independent of fixed traffic aggregation points such as WiFi access points, WLAN switches, and/or WiFi routers, and instead can leverage existing MBRI or WiFi access points for backhaul in a load leveling and self-healing manner. Because of the MANET waveform characteristics and the MANET architectural flexibility to deploy additional Backhaul Access Points or to upgrade existing MANET Access Points with backhaul capability, the MBRI may assure broadband bandwidth to the individual SD/MAP nodes in excess of conventional third generation or fourth generation (3G/4G) networks.

If combined with Dynamic Spectrum Awareness Networking (DySAN) protocol technology, the MBRI may coexist within existing defined spectrum with associated active network operations including WiFi networks. The present MBRI network may be integrated into or interoperate with and coexist with existing WLAN networks, Public Safety networks and sensor networks that are based on the IEEE 802 series standards such as 802.11 WiFi. DySAN may monitor and report on all aspects of the available RF spectrum to a host radio system including reporting, tracking, and proactively using spectrum that is available under a secondary usage or non-assured basis or on an opportunistic usage basis.

Integration options include a tightly coupled approach where the MBRI may act as a master controller for WiFi network with switching, where both radio systems share common radio resources such as the radio front end, antenna, baseband processing elements, or a loosely coupled arrangement where MBRI acts as a separate radio access and backhaul network to the WiFi network operations. Even when MBRI may be set up as a separate radio access network the spectrum can be shared in a cooperative or non-competing manner through the use of DySAN functionality within the MBRI technology.

The MBRI network may be set up in several configuration options with WiFi including:
A loosely coupled MBRI network integration option in which MBRI may only terminate calls or originate calls within the MANET, and similarly WiFi may only terminate and originate calls on the WiFi network, and there may be no call handoff capability between the networks, but transport facilities may be co-shared e.g. backhaul fiber transport.
A fully integrated MBRI network option where MBRI may provide time and frequency slots to the WiFi for full WiFi operations concurrently with MBRI usage using DySAN as a control mechanism to operate both networks concurrently.
A semi integrated MBRI and WiFi solution where the MBRI may share the WiFi AP's for transport for backhaul traffic to/from the Internet and may maintain the MANET operation on the access side. Or, vice versa, the MBRI network may provide backhaul support for existing WiFi by acting as a WiFi relay network or backhaul network.

The MBRI network configuration options above may share the same spectrum or different spectrum under a variety of regimes including:
Separate non-overlapping frequency bands
Co-shared bands under DySAN control
Secondary emitter status where either technology may be set up as the primary frequency and DySAN may be used to control the other technology as the secondary emitter based on data throughput requirements, signal quality requirements, time of day requirements, geographic separation or spatial variances

MBRI may be added as underlay or overlay network to increase tele-density, spectrum reuse, and capability in existing WiFi networks without requiring further spectrum purchases and expensive upgrades to the existing networks. MBRI as an underlay may reuse existing spectrum by recovering available white space based on DySAN policy control and spectrum awareness or through spectrum sharing within an existing network, and may optimize the use of existing facilities.

MBRI as an overlay may be used for “hole filling” between for WLAN coverage. In this manner, the spectrum used may be spatially or geographically separate and DySAN may or may not be important. Options for reusing existing facilities and/or databases may be the choice of the integration entity; all options are possible within the scope and spirit of the present invention.

Each node in an MBRI may act as its own name server in its own IP domain, supports filing services, may leverage distributed databases (via the Internet) and has access to geolocation information. Therefore, an individual MBRI node may act as its own radio access network, IP domain and/or underlay or overlay node in an existing WiFi/WLAN network, Public Safety network or sensor network (providing it may access the wired Internet via MBRI MAPs/BAPs or through shared facilities). MBRI may be integrated with WiFi and may act as a backhaul network for WiFi nodes or use WiFi nodes for backhaul transport services and/or allow for concurrent WiFi operation by providing DySAN support. With DySAN, an MBRI node may be able to provide spectrum time slots and frequency segments for WiFi operation. The MBRI router layer may support concurrent WiFi and/or MBRI MAC-PHY layer operations, in addition each network MAC-PHY may be implemented separately down to the chip level or the WiFi MAC may be implemented as a subset of the MBRI MAC. Note the PHY layer operations may require their own separate baseband RF processing elements.

MBRI WiFi integration and coexistence may be achieved in multiple different ways for loose or tight coupling. Spectrum sharing may only be performed through spectrum splitting (a crude option) or via DySAN. The present MBRI has much more flexibility in allowing open and proprietary extensions to the MBRI nodes at the BAP, MAP, or SD level since all nodes may support a service open architecture and open web applications downloading.

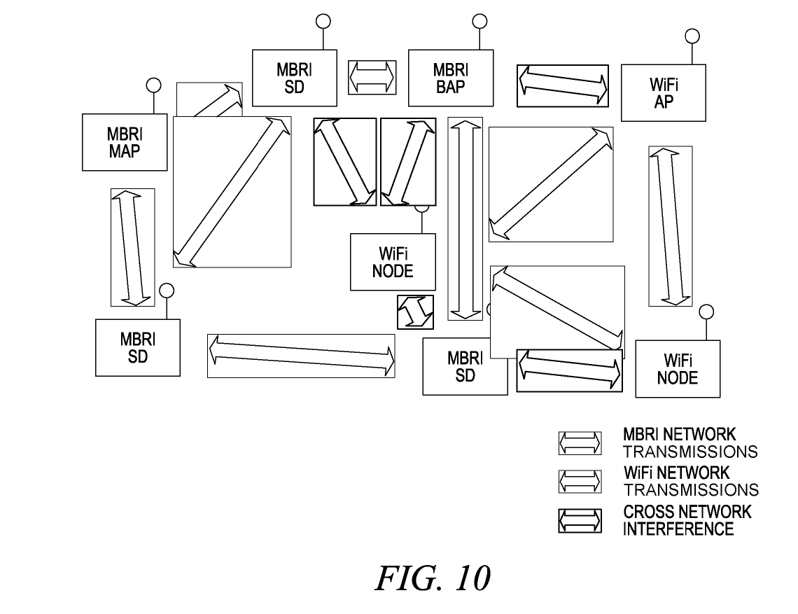

Coexistence is illustrated by reference to FIG. 10. Here, the MBRI and WiFi networks may operate in the same areas and in the same frequency band(s). Since there is no explicit coordination between networks, separate networks with different wireless ‘personalities’ cannot directly exchange messages over-the-air. Co-channel, partially overlapping, and adjacent channel transmissions can cause interference to the other system 440. Coexistence provides a solution for both concurrent and simultaneous operation within the multimode device.

In exemplary embodiments, there are three ways to implement coexistence in the MBRI system:
Seize and Hold Temporal Avoidance, where MBRI router transmits ‘channel hold’ transmissions to prevent WiFi from transmitting (2 ms in advance of data transfer).
Full-Frequency Avoidance, employing MBRI with DySAN (full 20 MHz RF channel bandwidth) to sense and adapt to avoid proximate WiFi activity.
Partial-Frequency Avoidance, employing MBRI sub-channel DySAN (2.5 MHz sub-channel BW) to spectrally operate in-between existing WiFi channels.

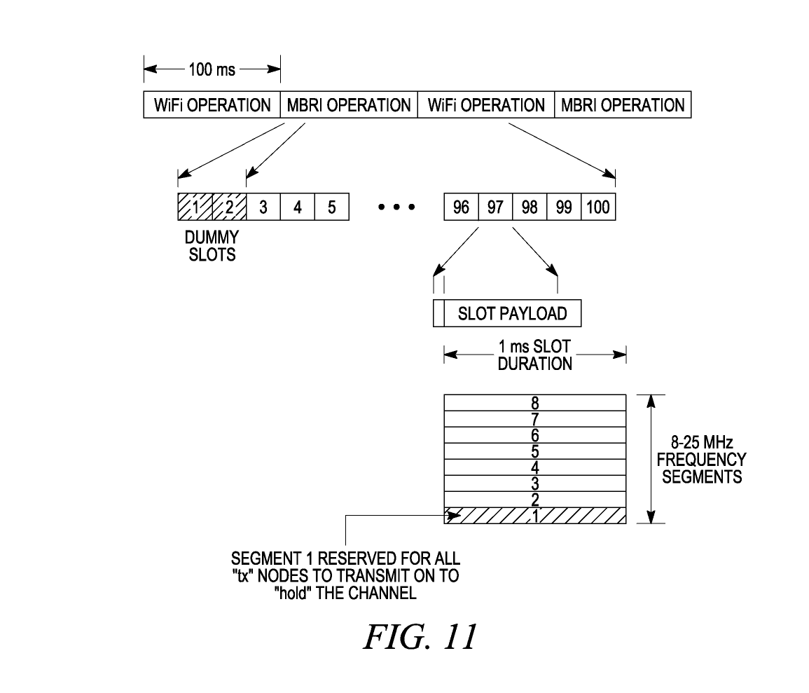

Seize and Hold Temporal Avoidance is illustrated in FIG. 11. Initially, the transmit timeline may be partitioned into segments designated for each technology (WiFi, MBRI), i.e., superframes. MBRI protocols operate using “punctured” timeline, which is a subset of available slots. In some embodiments, there are 96 slots in each MBRI interval. The first two slots (two DIFS windows, or 2 msec in duration, in this example) may be reserved as “dummy slot” transmissions at start of MBRI interval.

Legacy WiFi nodes unaware of timeline partitioning must be “tricked” into silence. The MBRI nodes are silent and/or sensing other RF channels during WiFi operation period. Nodes designated as “transmitters” on a given slot must transmit one segment every slot to hold the channel, i.e., to protect against pending 802.11 transmissions. Accordingly, in this exemplary embodiment, each slot has an inter-slot guard time of less than or equal to 34 μsec to prevent 802.11 transmissions. Since multiple nodes in a neighborhood are transmitting on segment 1, this “lost capacity” is filled with dummy data.

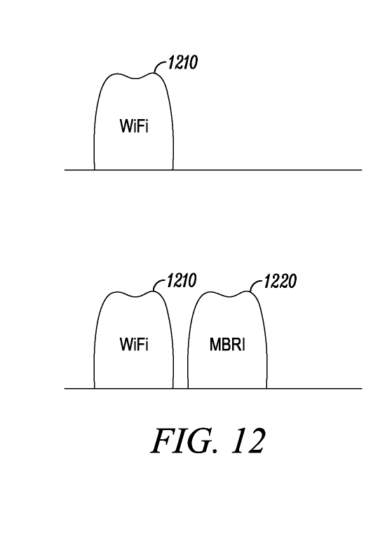

Full-Frequency Avoidance is illustrated in FIG. 12. This is the basic avoidance technique achieved using DySAN to select a vacant RF channel 1220 when a WiFi user 1210 is encountered. In some embodiments, it is employed upon start-up of the system and may be used for adaptation due to mobility or due to a changing environment (e.g., when a new emitter turns on nearby). The DySAN architecture and systems support multi-node operation across different RF channels to account for spatial RF occupancy pattern.

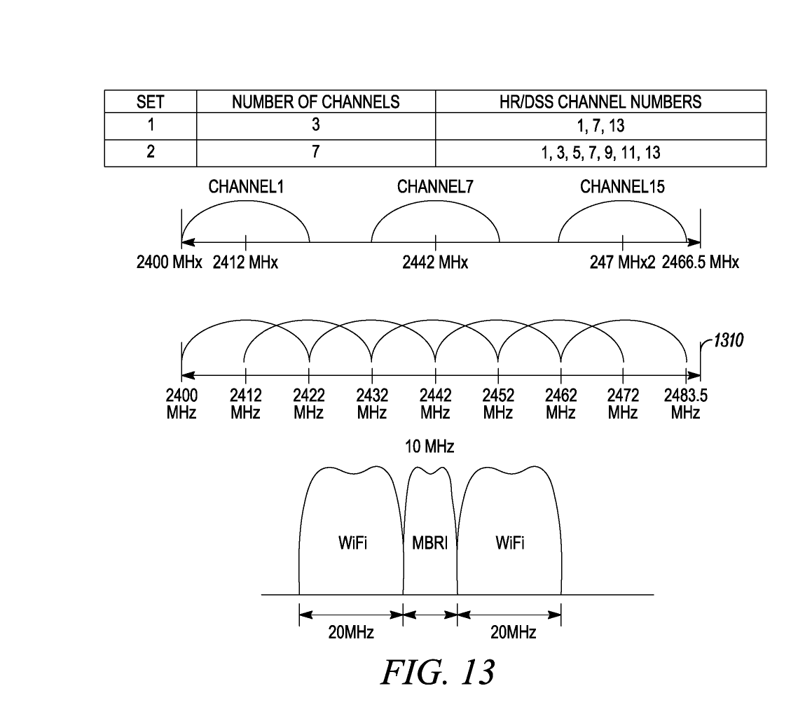

Partial-Frequency Avoidance is illustrated in FIG. 13. In certain environments, the unlicensed 2.4 GHz frequency band may contain multiple partially overlapping frequency channels 1310. DySAN control allows adaptive RF BW by turning segments (sub-channels) on/off.

### MBRI Device Integration

In embodiments, the MBRI Management technology may be embodied in a four layer ISO (International Standards Organization) OSI (Open Systems Interconnection) reference model stack. Layer 1, the physical (PHY) layer, uses a symmetrical waveform based on, for example and not by way of limitation, OFDMA, QAM, SC-OFDMA, CDMA, or TDMA technology. The waveform allows for bi-directional communications without a downlink or uplink protocol difference and relies on higher layer entities to manage output power, transmission mode, traffic types, and time synchronization functions. Layer 2, the media access control (MAC) layer, provides a high quality peer-to-peer packet transmission/reception protocol for passing frames between nodes and for distinguishing between peer-to-peer, peer to network, and network to peer traffic. The MAC layer also manages the radio resources of a single node and control subnetwork layer convergence functions such as segmentation and reassembly, quality of service (QoS), throughput fairness, adaptive data rate control and transmit power control. Layer 2 may be extensible to support the MAC functions and PHY functions for WiFi with integrated 3^{rd} party Application Programming Interfaces (APIs) for WiFi MAC functions of 3^{rd} party silicon solutions. Layer 3, the network layer, provides for full transparency with the internet through a border gateway protocol edge router, and makes transparent all TCP/IP and UDP functions at the routing level viz. OSPF. The router may also be responsible for application awareness, multicast and unicast operations and IPv4 and IPv6 transparency. The router may be able to concurrently support MBRI and WiFi traffic streams and IP services without enhancement. Furthermore, the router layer may weight the traffic based on “least cost” metrics or other proprietary rules. Layer 4 may be the OSS applications, which may be based on prevailing web standards and OSS standards. Layer 4 may be an open access layer and support the ad hoc downloading and development of custom or network-wide client applications, applets, servlets, and protocols. Layer 4 may also allow for the development of custom and open gateways and protocols for 3^{rd} party facilities, database, signaling and media access, and control. Layer 4 may be an open layer available to any type of Java, C++, and C programming language extensions through beans, Applet, servlet, thin client or fat client applications or installations. These extensions may embody open or closed proprietary protocols or applications as long as they may be web service open architecture compliant (i.e. downloadable and manageable over the web).

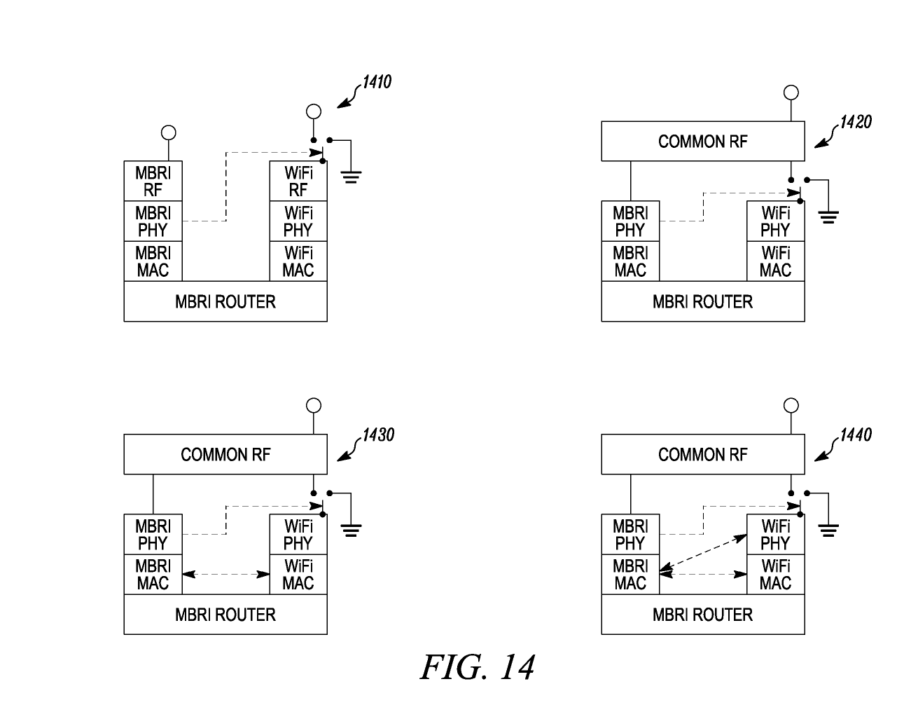

FIG. 14 depicts four alternate embodiments 1410, 1420, 1430, and 1440, representing different levels of multi-mode device integration for implementing an MBRI router according to some embodiments of the present invention. Block diagram 1410 represents two complete solutions in a single device, where an MBRI router is aware of WiFi interface. In this implementation, the antenna could be shared. The MBRI places a “blanking signal” on the RF front-end of co-device WiFi.

Alternatively, in block diagram 1420, the RF chain is shared with multiple MAC interfaces. In a further alternative embodiment 1430 with a shared RF chain, message passing and/or information sharing between MAC layers is also provided. In yet a further embodiment 1440 with a shared RF chain, the MBRI elements provide command of the WiFi “utility” transmissions.

These multimode devices may be configured, in some exemplary embodiments, to operate in a number of different ways. For example, when operating in an “either/or” or “Multiple Personality” mode, the MBRI and WiFi systems can be operated in any of the following configurations:
MBRI network primary; WiFi network secondary
Node boots-up and searches for MBRI network
Node participates in MBRI network until “out-of-network” for some defined duration
Node searches for WiFi network
If found, node joins WiFi network, else alternates search for MBRI and WiFi networks
While part of WiFi network, node periodically searches for MBRI network

If, however, the MBRI and WiFi systems are operating simultaneously, the node participates in both MBRI and WiFi networks (i.e., separate NICs). This may include operation in the temporal co-existence scenario with channel change (if needed) between alternating technology superframes. The MBRI operation duty cycle is adaptive based on observed dynamic traffic requirements of both networks, because the MBRI router is aware of both network interfaces and can route through either. As noted above, the MBRI network uses DySAN on both full and partial channels to find “free” spectrum.

### Embodiments Utilizing 802.11 Network Chipsets

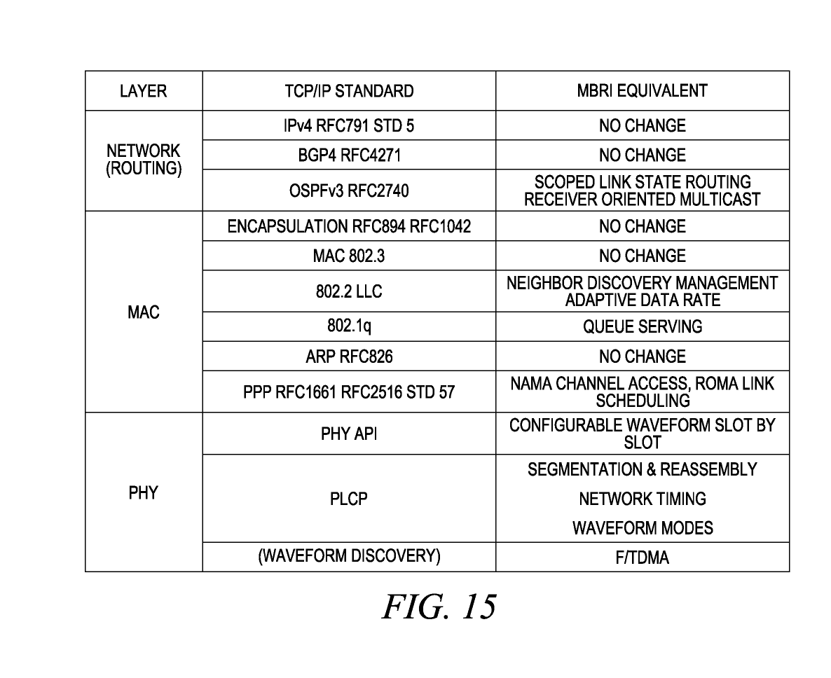

As shown in FIGS. 15-17, an ad hoc network modem (or device using such a modem) for use in an MBRI network or the like may be realized using existing chipsets designed for operation within the 802.11 network standard.

FIG. 15 illustrates the upper layers of the MBRI software stack, according to one embodiment of the present invention. These layers may, in an exemplary embodiment, be ported to the WiFi physical (PHY) layer, such as in an API between a physical layer radio and an 802.11 chipset, and therefore utilize the various WiFi waveform modes including those based on well known access methods, such as but not limited to FHSS, DSSS, OFDMA, and the like. This allows the MBRI routing and MAC layer protocols to provide some of the same ad hoc, peer-to-peer, self-forming, self-healing, geolocation, neighborhood routing, and control and edge to edge scalability and routing capabilities of the MBRI networks described herein using commercial off the shelf WiFi components such as chips, modules, boards, host processors and dongles.

This approach may provide the various features and advantages of MBRI network systems described herein to a pre-existing base of existing WiFi products. For example, this may be applied to an existing infrastructure of WiFi networks and hotspots by permitting a download of MBRI software as host based drivers and software without requiring hardware retrofit or software changes to existing products, terminals, devices and Access Points. All MBRI software can be downloaded and installed remotely using any of the well known, commonly used installation techniques such as, but not limited to, install shields, wizards, FTP, TFTP, FTAM, and the like, or any other suitable file transfer or downloading protocols.

In this manner, WiFi can be enhanced to provide full MBRI capability including dynamic mobile routing, peer-to-peer routing and communications, ad hoc network build-out, dense spectrum reuse, co-channel cooperation (as opposed to co-channel competition), graceful scaling, graceful saturation, session persistence across the network, full mobility across the network, non-GPS based geolocation using MBRI time difference of arrival (TDOA), ability to leverage MBRI applications such as swarming, rapid nodal births and deaths, full OSPF and Border Gateway Protocol (BGP) transparency with MBRI radio aware routing.

Furthermore, this approach addresses one drawback of MBRI deployments—the need for MBRI radio infrastructure—by allowing MBRI networks to deploy on top off existing WiFi networks (or beneath existing networks, for the point of view of the network protocol) by installing suitable software in various access points, devices, dongles, laptops, smart phones, PC cards, chips, and the like across an existing WiFi network. Thus, this approach advantageously permits deployment of MBRI networks while mitigating the need for a wholesale replacement of hardware and devices.

Existing WiFi networks have the advantage of existing, commercial off-the-shelf (COTS) 802.11-based modems. It is therefore desirable to be able to implement the MBRI stack on these COTS chipsets. The COTS modems (or chipsets) are generally designed for mass-market adoption. Their low cost drives high volume. They are generally single carrier designs designed for a specific market band or bands. They are primarily single hop, point-to-point transmission systems.

Typical COTS 802.11 modem chipset implementations focus on maximum throughput for a target end-user application; they have few transmission modes and back-off options. Because they are built to address specific standards, these chipsets typically have few options for adaptability to other market requirements or usage scenarios. However, silicon providers do provide maximum options for utilization in other market environments, including support of multiple bus types and operating systems.

COTS 802.11 modem chipsets are also designed to preserve or optimize battery life in end-user devices and have multiple options for sleep mode and multiple options to preserve power including adaptive power control. The PHY and MAC layer functions are usually separated and the open MAC drivers enable SW customization. The present invention takes advantage of these aspects to add the MBRI software stack onto COTS chips in order to implement the MBRI router functions in currently available hardware.

The latest generation of WiFi chips supports a hardware state machine for the PHY and the MAC that is entirely in software. So-called “thick driver” implementations for host based drivers e.g. for Windows and Apple platforms are also currently available. In addition, thin implementations for on-board or real-time operating systems are available.

Implementation of the MBRI stack is aided by the fact that several features can be turned off via register control and set up at initialization including: ACK/NAK handling (optional to begin with) and RTS/CTS, which is an optional 802/11e feature. Implementations of the present invention do need to turn off the CSMA/CA processing, which would otherwise interfere with the protocols and MAC control algorithms used in MBRI. Carrier Sense Multiple Access With Collision Avoidance (CSMA/CA). As that term is known in the networking arts, is a wireless network multiple access method that uses a carrier sensing scheme to avoid collisions. A node wishing to transmit data has to first listen to the channel for a predetermined amount of time to determine whether another node is transmitting on the channel within the wireless range. If the channel is sensed as idle, then the node is permitted to begin the transmission process. If the channel is sensed as busy, the node defers its transmission for a random period of time.

In addition, in some embodiments of the present invention, the software must implement a “Timeslot API” and configure the 802.11 chipset into a slotted time-division multiple access (TDMA) mode, since it is already time-division duplexing (TDD) in nature. Furthermore, the standard 802.11 DCF [Distributed Coordination Function] Interframe Space (DIFS) processing can also be turned off via register control. As a result, all station interference, collisions, back-off timing and scheduling are under the control of MBRI, not the PHY driver, giving the system the ability to use the MBRI control protocols to determine slot winners and losers in a neighborhood.

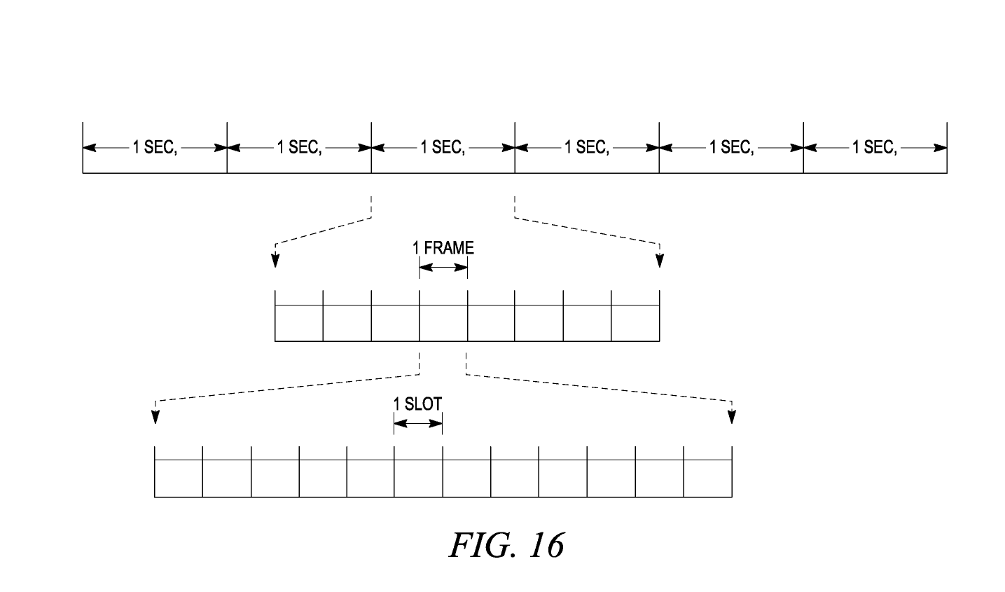

FIG. 16 depicts a slotted TDMA timing structure according to one embodiment of the present invention. Each time interval is subdivided into multiple epochs. There is a 1 pulse per second (pps) signal from the GPS in each AP and an artificially generated 1 pps signal in subscriber devices. Each 1 second interval subdivided into integer number of frames and each frame subdivided into integer number of slots per frame. The fundamental slot rate in number of slots per second is 1000 slots/sec. nominal (1 msec each). Slot transmissions are algorithmically scheduled by means of algorithms well known in the art.

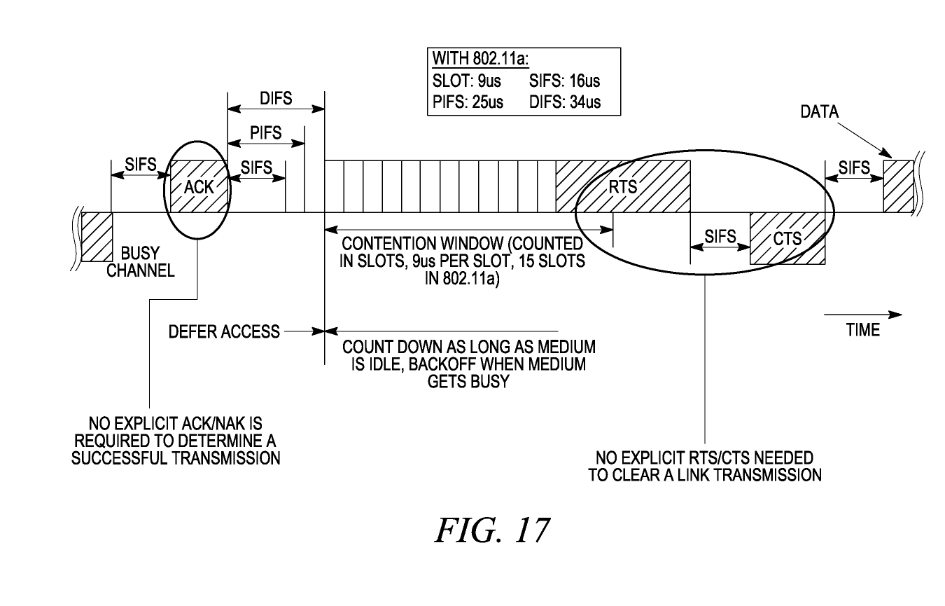

FIG. 17 illustrates some aspects of the current 802.11 timing and message passing scheme that can be avoided in an exemplary embodiment of the MBRI implementation. Using MBRI and DySAN co-channel cooperation technology of the present invention allows nodes (based on node metrics) to asynchronously determine slot winners in their neighborhood, there is no radio contention. Accordingly, the explicit ACK/NAK and RTS/CTS messages are not required. Furthermore, link scheduling algorithms prevent link contention between neighborhoods. Since the CSMA/CA function is based on the Distributed Coordination Function in the standard 802.11 MAC layer implementation, the back-off procedure would be initiated after an idle time of DIFS. However, since the MBRI and DySAN technology avoids this possibility, the DIFS processing can also be disabled.

To summarize, the MAC-PHY Layer interactions in embodiments of the present invention may include the following:

802.11 Standard API Example

Receive:
[symbol] PHY_CCA.ind—Clear channel indication from PHY (Busy/Idle)
[symbol] PHY_RXSTART.ind—Indication from PHY that receive has begun; includes Length and RSSI parameters
[symbol] PHY_DATA.ind—Indication from PHY that data is arriving
[symbol] PHY_TXEND.ind—Indication from PHY that transmission has ended

Transmit:
[symbol] PHY_TXSTART.req—Instruction to PHY to initiate transmission; includes parameters: Length, Data Rate, Service, TXPWR_LEVEL
[symbol] PHY_TXSTART.conf—Confirmation from PHY that transmission has begun
[symbol] PHY_DATA.req—Request to PHY for data transmission
[symbol] PHY_DATA.conf—Transmission confirmation from PHY
[symbol] PHY_TXEND.req—“End of Transmission” signal sent to PHY
[symbol] PHY₊TXEND.conf—“End of Transmission” confirmation from PHY

MBRI API, where extensions to the standard 802.11 API are noted in italics

Receive:
[symbol] 1 PPS signal
[symbol] PHY_RXSTART.ind—Indication from PHY that receive has begun; includes Length and RSSI parameters plus SNR
[symbol] PHY_DATA.ind—Indication from PHY that data is arriving plus slot number information
[symbol] PHY_TXEND.ind—Indication from PHY that transmission has ended

Transmit:
[symbol] PHY_TXSTART.req—Instruction to PHY to initiate transmission; includes parameters: Length, Data Rate, Service, TXPWR_LEVEL plus slot number information
[symbol] PHY_TXSTART.conf—Confirmation from PHY that transmission has begun
[symbol] PHY_DATA.req—Request to PHY for data transmission
[symbol] PHY_DATA.conf—Transmission confirmation from PHY
[symbol] PHY_TXEND.req—“End of Transmission” signal sent to PHY
[symbol] PHY_TXEND.conf—“End of Transmission” confirmation from PHY

In addition, the MBRI implementation includes a timeslot API (described above) that passes packets between the MBRI MAC and the 802.11p PHY layers.

### Alternate Embodiments

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer program product or computer executable code (which may be stored in memory) created using a structured programming language such as (but not limited to) C, an object oriented programming language such as (but not limited to) C++, or any other high-level or low-level programming language (including but not limited to assembly languages, hardware description languages, and database programming languages and technologies) that may be stored, executed, compiled or interpreted to run on one of the above devices, as well as heterogeneous combinations of processors, processor architectures, or combinations of different hardware and software.

Thus, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

I claim:

1. A method for implementing an ad hoc wireless router function in an 802.11 chipset, comprising:
configuring the chipset to disable CSMA/CS processing;
configuring the chipset into slotted TDMA mode; and
configuring the chipset to implement an extended API for:
passing packets between the MAC and PHY layers using at least a timeslot;
exchanging at least an RSSI parameter and a timeslot number parameter; and
providing a 1 pulse per second timing signal.

2. The method of claim 1, further comprising:
disabling ACK/NAK handling; and
disabling RTS/CTS handling.

3. The method of claim 1, further comprising:
disabling DIFS processing

4. The method of claim 1, wherein configuring the chipset to implement an extended API further comprises:
exchanging a SNR parameter.

5. A method of managing and operating an MBRI router in a network with a plurality of wireless nodes and a plurality of wireless communication links connecting the plurality of nodes, the method comprising:
transmitting a channel hold signal to prevent at least one wireless node from transmitting.

6. The method of claim 5, wherein the channel hold signal transmitting occurs within two DIFS windows in advance of a data transfer.

7. The method of claim 5, wherein the wireless communication links are WiFi links.

8. The method of claim 5, further comprising providing real-time and non real-time downloading of node specific and network specific protocols for linking one or more MBRI nodes and end user nodes with at least one of a WiFi network, a WLAN, and a WiFi based Public Safety network.

9. The method of claim 5, further comprising providing real-time and non real-time downloading of node specific and network wide applets, servlets, and client applications for linking one or more MBRI nodes and end user nodes with at least one of a WiFi network, a WLAN, and a WiFi based Public Safety network.

10. A method of method of managing and operating an MBRI router in a network with a plurality of wireless nodes and a plurality of wireless communication links connecting the plurality of nodes, the method comprising:
coordinating neighbor interference using DySAN over about a 20 MHz RF channel bandwidth.

11. The method of claim 10, wherein the wireless communication links are WiFi links.

12. The method of claim 10, further comprising providing real-time and non real-time downloading of node specific and network specific protocols for linking one or more MBRI nodes and end user nodes with at least one of a WiFi network, a WLAN, and a WiFi based Public Safety network.

13. The method of claim 10, further comprising providing real-time and non real-time downloading of node specific and network wide applets, servlets, and client applications for linking one or more MBRI nodes and end user nodes with at least one of a WiFi network, a WLAN, and a WiFi based Public Safety network.

14. A method of method of managing and operating an MBRI router in a network with a plurality of wireless nodes and a plurality of wireless communication links connecting the plurality of nodes, the method comprising:
coordinating neighbor interference using DySAN over about a 2.5 MHz RF subchannel bandwidth operating between existing wireless communication link channels.

15. The method of claim 14, wherein the wireless communication links are WiFi links.

16. The method of claim 14, further comprising providing real-time and non real-time downloading of node specific and network specific protocols for linking one or more MBRI nodes and end user nodes with at least one of a WiFi network, a WLAN, and a WiFi based Public Safety network.

17. The method of claim 14, further comprising providing real-time and non real-time downloading of node specific and network wide applets, servlets, and client applications for linking one or more MBRI nodes and end user nodes with at least one of a WiFi network, a WLAN, and a WiFi based Public Safety network.
